(19) United States
(12) Patent Application Publication
(10) Pub. No.: US 2006/0037836 A1
(43) Pub. Date: Feb. 23, 2006

(54) Sorting device for coin tester

(76) Inventor: Roland Griese, Berlin (DE)

Correspondence Address: YOUNG & BASILE, P.C., 3001 WEST BIG BEAVER ROAD, SUITE 624, TROY, MI, 48084, US

(21) Appl. No.: 11/209,064

(22) Filed: Aug. 22, 2005

(30) Foreign Application Priority Data
Aug. 23, 2004 (DE) 102004041673.755

(51) Int. Cl. G07D 5/08; G07F 1/04

(52) U.S. Cl. 194/324; 194/346

(57) ABSTRACT

A sorting device for a coin tester, with a frame for fastening the coin tester and a sorting unit arranged on the frame which comprises at least one opening for the passage of a coin exiting from the coin tester is suggested. Elements which may be actuated by way of electromagnets are provided in the sorting unit and these elements release or block various coin paths depending on the activation of the electromagnets. The movable elements are designed as deflection levers which are pivotable in the plane of the running direction of the coins, are articulated to one another at a distance which is seen as transverse to the running direction, and are guided in arch-shaped guides.

### BACKGROUND OF THE INVENTION

The invention relates to a sorting device according to the preamble of the main claim.

Sorting devices are generally connected to coin testers and guide a coin exiting from the coin tester into a suitable channel or coin path. Deflection elements are provided for the guiding which may be actuated by a control via electromagnets. Such a sorting device for example is disclosed in EP 0 511 150 B1. With this, the deflection elements are moved linearly, i.e. perpendicular to the plane in which the running direction of the respective coin lies, by way of an electromagnet with a tension rod. Such a sorting device has the disadvantage that the thickness of the sorting device is quite noticeable due to the tension rod. Furthermore, electromagnets with tension rods with regard to the cost of manufacture are very much more expensive for example compared to flap armature (electro)magnets. Furthermore the movement of the tension rod must be effected in a very quick manner, wherein this is only the case if the operating voltage is correct. This means that with fluctuations in voltage, an error-free manner of functioning is not ensured since the coins may become clamped-in due to the delayed movement of the deflection elements.

### SUMMARY OF THE INVENTION

It is therefore the object of the invention to provide a sorting device according to the preamble of the main claim which allows a more reliable manner of functioning of the sorting and classification of the coins and whose manufacture is more economical.

According to the invention, the characterising features of the main claim in combination with the features of the preamble achieve this object.

By way of the fact that the moving elements are designed as deflection levers pivotable in the plane of the running direction of the coins and are articulated at a distance to one another transversely to the running direction and are guided in arch-like guides, a reliable deflection becomes possible, since an arriving coin encourages the movement of the respective deflection lever in the sorting direction. A coin may not become clamped since the pivoting movement takes place in the plane of the running direction.

Advantageous further designs and improvements are possible by way of the measures specified in the dependent claims.

Since the deflection levers at their one end are engaged with a multiplication lever, the pivoting path may be increased, by which means flap armature (electro)magnets which carry out only a small movement may be used, these being much less expensive. The multiplication levers are dimensioned such that for example a pivot movement of the flap armature of 1 mm corresponds to a pivot movement of the deflection lever of 30°.

Preferably knob-like projections which run in guide paths are integrally formed on the deflection levers. These knob-like projections simultaneously serve as abutments and accommodate forces when the deflection lever is hit by a coin, by which means the rotation arbor of the deflection lever is treated gently.

### BRIEF DESCRIPTION OF THE DRAWINGS

One embodiment example of the invention is represented in the drawing and is explained in more detail in the subsequent description. There are shown in:

FIG. 1 a perspective view of the sorting device, from the rear side,

FIG. 2 a perspective view of the sorting device from the front side, i.e. from the opposite side to FIG. 1, with electromagnets,

FIG. 3 and FIG. 4 a plan view of the rear side of the sorting device in two different positions of the deflection lever, wherein the electromagnets and multiplication levers of the front side have also been drawn in.

### DETAILED DESCRIPTION

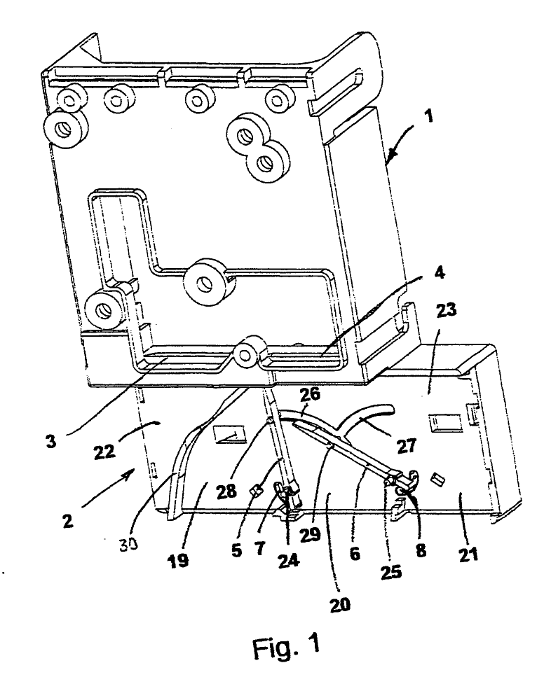

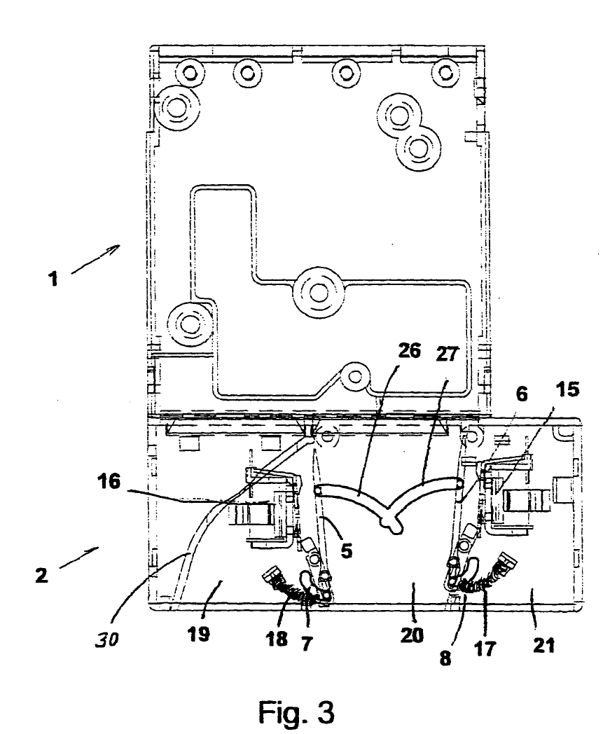

The arrangement of a sorting device represented in FIG. 1 to FIG. 4 comprises a frame 1 which serves for accommodating a coin tester, and a sorting unit 2 which is connected to the frame 1 as one piece.

Openings 3, 4 are provided between the frame 1 and the sorting unit 2 which serve for leading the coins which exit the coin tester further to the sorting unit. A curved, downwardly directed coin path 30 is located below the opening 3 and guides a coin which has not been accepted into the return provided on a narrow side of the sorting unit 2.

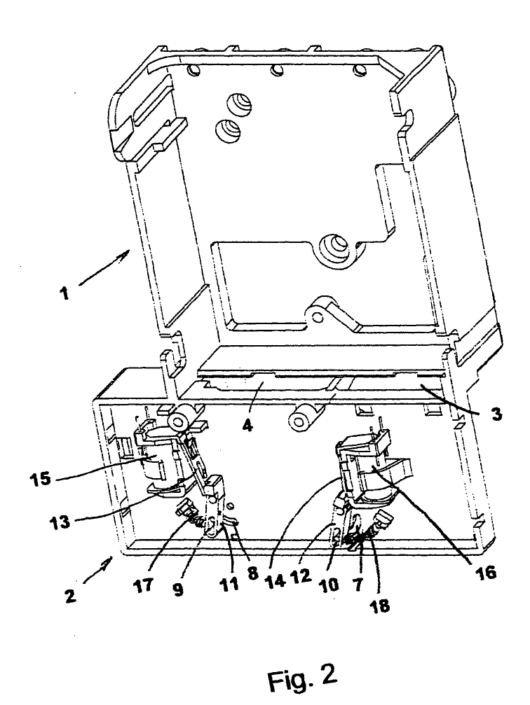

The view of the deflection levers 5, 6 is to be seen in FIG. 1, which where appropriate deflect the arriving coins in the respective direction. The deflection levers 5, 6 in each case with their lower end on which a projection is outwardly formed engage through an arch-like opening 7, 8, and as is to be seen in FIG. 2, engage in an elongate hole 9, 10 of a multiplication lever 11, 12. The multiplication levers 11, 12 in each case are in contact with a flap armature 13, 14 of a flap armature electromagnet 15, 16. The electromagnets 15, 16 are activated by a control which is not shown. Furthermore restoring springs 17, 18 are allocated to the multiplication levers 11, 12 and press the deflection levers 5, 6 into the vertical base position.

Basically three coin channels or coin paths are provided in the region of the deflection levers 5, 6. A first coin channel 19 which is also in connection with the coin opening 3, a second coin channel which is limited by the two roughly vertical deflection levers 5, 6 and a third coin channel 21, wherein all coin exits of these channels 19, 20, 21 lie next to one another in the longitudinal direction of the sorting device.

The deflection levers 5, 6 in the vicinity of their ends which are guided in the arch-like openings 7, 8 are pivotably mounted in the side walls 22, 23 of the sorting device via the pivot points 24, 25. Guides 26, 27 are machined into these side walls, which are designed in an arch-like manner and together form a wide-open V-shape or have the contour of a flying swallow. Knob-like projections 28, 29 engage into these guides 26, 27 and these projections are integrally formed on the deflection levers 5, 6 on both sides. These knob-like projections 28, 29 simultaneously serve as abutments at the ends of the guides 26, 27.

The front side of the sorting device unit 2 according to FIG. 1 is closed by a lid which is not shown and which likewise comprises guides 26, 27 and mounting holes for the accommodation of the pivot projections 24, 25.

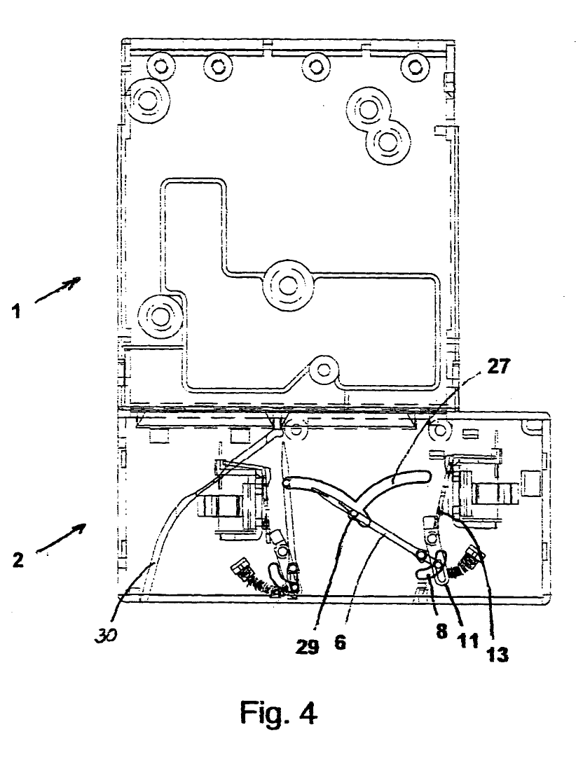

The manner of functioning of the sorting device is as follows. When the electromagnets 15, 16 are not subjected to current or excited, the flap armatures 13, 14 are in their rest position and the restoring springs 17, 18 via the multiplication levers 11, 12 press the flap armatures indeed into this rest position, and the deflection levers 5, 6 into the vertical direction according to FIG. 4. With this, the first coin channel 19 and the third coin channel 21 is blocked for coins which are led through the opening 4, so that the coin takes the path vertically downwards through the second channel 20.

If the electromagnet 15 is subjected to current or activated, the flap armature 13 pivots away from the magnet and presses against the multiplication lever 11 which presses against the restoring spring 17, and displaces the end of the deflection lever 6 in the arch-like opening 8 as well as in the elongate hole 9, by which means the deflection lever 6 pivots in the guide 27. The coin channel 20 is closed by way of this and a coin which comes through the coin opening 4 is guided into the third coin channel 21. If the movement of the deflection lever 6 in the guide has not yet been completely when the coin drips, the coin additionally presses the lever into the end position as is shown in FIG. 4. At the same time the knob-like projections 29 serve as an abutment and accommodate the force exerted by the coin. The multiplication lever 11 serves for increasing the pivot movement exerted by the flap armature 13 which is transmitted onto the deflection lever 6. At the same time the multiplication lever 11 for example is dimensioned such that with a 1 mm pivot movement of the flap armature 13, the deflection lever has a pivot angle of 30°.

The other electromagnet 16 may be activated in a corresponding manner, wherein the deflection lever 6 is in the vertical direction, and the deflection lever 5 is pivoted according to the guide path 26 in the same manner, as described above, by which means the coin path 20 is closed but the coin path 19 is released. Here too the movement of the coin supports the movement of the deflection lever 5 into the position closing the coin path 20.

In the described embodiment example restoring springs 17, 18 are allocated to the deflection or multiplication levers. However a tension spring may also be provided between the multiplication levers 11, 12 which presses the deflection levers 5, 6 into the rest position.

What is claimed is:

1. A sorting device for a coin validator, with a frame for fastening the coin tester and with a sorting unit which is arranged on the frame and which comprises at least one opening for the passage of a coin exiting the coin validator, wherein movable elements capable of being actuated by way of electromagnets are provided in the sorting unit, which release or block various coin paths depending on the activation of the electromagnets, wherein the movable elements are designed as deflection levers which are pivotable in the plane of the running direction of the coins, are articulated to one another at a distance seen transversely to the running direction and are guided in arch-like guides.

2. A sorting device according to claim 1, wherein the arch-like guides of the two deflection levers have a wide-open V-shape or the contour of a flying swallow.

3. A sorting device according to claim 1, characterised in that the electromagnets are designed as hinged-armature solenoid.

4. A sorting device according to claim 3, characterised in that the respective deflection lever is engaged with a transmission lever which may be moved by the hinged-armatures.

5. A sorting device according to claim 1, characterised in that the deflection lever in the non-activated condition of the electromagnets are roughly upright and between them free a coin path.

6. A sorting device according claim 1, characterised in that the deflection levers on activation of the electromagnets may be pivoted in the running direction of the coins.

7. A sorting device according claim 1, characterised in that the deflection levers in each case comprise at least one knob-like projection for the engagement into the arch-like guide, wherein the projections simultaneously serve as abutments and a force-accommodating element on coming into contact with a coin.

8. A sorting device according to claim 2, characterised in that the electromagnets are designed as hinged-armature solenoid.

9. A sorting device according to one of the claims 2, characterised in that the deflection lever in the non-activated condition of the electromagnets are roughly upright and between them free a coin path.

10. A sorting device according to one of the claims 3, characterised in that the deflection lever in the non-activated condition of the electromagnets are roughly upright and between them free a coin path.

11. A sorting device according to one of the claims 4, characterised in that the deflection lever in the non-activated condition of the electromagnets are roughly upright and between them free a coin path.

12. A sorting device according to one of the claims 2, characterised in that the deflection levers on activation of the electromagnets may be pivoted in the running direction of the coins.

13. A sorting device according to one of the claims 3, characterised in that the deflection levers on activation of the electromagnets may be pivoted in the running direction of the coins.

14. A sorting device according to one of the claims 4, characterised in that the deflection levers on activation of the electromagnets may be pivoted in the running direction of the coins.

15. A sorting device according to one of the claims 5, characterised in that the deflection levers on activation of the electromagnets may be pivoted in the running direction of the coins.

16. A sorting device according to one of the claims 2, characterised in that the deflection levers in each case comprise at least one knob-like projection for the engagement into the arch-like guide, wherein the projections simultaneously serve as abutments and a force-accommodating element on coming into contact with a coin.

17. A sorting device according to one of the claims 3, characterised in that the deflection levers in each case comprise at least one knob-like projection for the engagement into the arch-like guide, wherein the projections simultaneously serve as abutments and a force-accommodating element on coming into contact with a coin.

18. A sorting device according to one of the claims 4, characterised in that the deflection levers in each case comprise at least one knob-like projection for the engagement into the arch-like guide, wherein the projections simultaneously serve as abutments and a force-accommodating element on coming into contact with a coin.

19. A sorting device according to one of the claims 5, characterised in that the deflection levers in each case comprise at least one knob-like projection for the engagement into the arch-like guide, wherein the projections simultaneously serve as abutments and a force-accommodating element on coming into contact with a coin.

20. A sorting device according to one of the claims 6, characterised in that the deflection levers in each case comprise at least one knob-like projection for the engagement into the arch-like guide, wherein the projections simultaneously serve as abutments and a force-accommodating element on coming into contact with a coin.
